(19) United States
(12) Patent Application Publication
(10) Pub. No.: US 2006/0291132 A1
(43) Pub. Date: Dec. 28, 2006

(54) Electrostatic chuck, wafer processing apparatus and plasma processing method

(76) Inventors: Seiichiro Kanno, Tokyo (JP); Tsunehiko Tsubone, Hikari-shi (JP); Masakazu Isozaki, Kudamatsu-shi (JP); Toshio Masuda, Tokyo (JP); Go Miya, Tokyo (JP); Hiroho Kitada, Kudamatsu-shi (JP); Tooru Aramaki, Kudamatsu-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/370,102

(22) Filed: Mar. 8, 2006

(30) Foreign Application Priority Data
Jun. 28, 2005 (JP) 2005-188341
Aug. 26, 2005 (JP) 2005-245174
Feb. 13, 2006 (JP) 2006-035034

(51) Int. Cl. H01T 23/00

(52) U.S. Cl. 361/234

(57) ABSTRACT

An electrostatic chuck which is built in a heater and can change, at a high speed, the temperature distribution of a wafer being processed by a plasma is provided at low cost. Also, there is provided a processing method which realizes uniform etching by suppressing CD variations in the plane of the wafer even when etching conditions change. The electrostatic chuck includes a base material in which multiple coolant grooves are formed, a high resistance layer which is formed on the base material, multiple heaters which are formed by thermally spraying conductors within the high resistance layer, multiple electrostatic chuck electrodes which are formed similarly by thermally spraying conductors within the high resistance layer, and temperature measuring means, and adjusts outputs of the heaters on the basis of temperature information of the temperature measuring means.

The present application is based on and claims priority of Japanese patent application No. 2006-035034 filed on Feb. 13, 2006, the entire contents of which are hereby incorporated by reference.

### BACKGROUND OF THE INVENTION

1. Field of the Invention

The present invention relates to an etching technique of a semiconductor wafer and, more particularly, to a wafer processing apparatus which continuously processes a semiconductor wafer.

2. Description of the Related Art

In recent years, circuit patterns processed in a semiconductor wafer have kept on becoming increasingly fine owing to high-density designs of semiconductor elements and required dimensional accuracies in processing have become more and more severe. Under such circumstances, the temperature control of a wafer (semiconductor wafer) being processed becomes a very important matter.

For example, in etching a wafer by using a plasma, usually, bias voltage is applied to the wafer and ions are accelerated by an electric field and drawn into the wafer, whereby an anisotropic shape is realized. Because heat input to the wafer occurs at this time, the temperature of the wafer rises.

This rise in wafer temperature has an effect on etching results. For example, a line width which is finally obtained is greatly affected by the re-adhesion of reaction products which adhere to side walls during etching and the adhesion of depositable radical species. However, the adhesion ratio of these adhering substances changes depending on wafer temperature. Therefore, if the temperature control of a wafer which is being processed is not sufficient, non uniform etching results in the wafer plane are obtained or etching results with poor reproducibility among wafers are obtained. In addition, because the distribution of reaction products has a lower density in portions near the periphery of the wafer than near the center of the wafer, it is necessary to positively control the temperature distribution of the wafer in order to obtain a uniform line width (critical dimension, CD) in the wafer plane.

Also, because the density distribution of reaction products and depositable radical species on the wafer changes also depending on etching conditions, in a case where etching conditions are changed in order to process different kinds of films during one step of processing as in the case of the continuous processing of a BARC (bottom anti-reflection coating) and polysilicon, an optimum temperature distribution changes depending on the conditions.

However, it has hitherto been general practice to adjust the temperature of an electrostatic chuck, which becomes a wafer stage, to a constant level by using a coolant discharged from a temperature adjuster for the purpose of controlling an average temperature distribution of the wafer and to ensure heat transfer by introducing a heat conducting gas, such as helium, to between the wafer and the electrostatic chuck. Under this method, wafer temperature does no rise abruptly even in a case where the quantity of heat input from a plasma is large because a coolant has a large heat capacity, and this method has the advantages that the temperature is relatively stable. However, this method is not suitable for changing wafer temperature with good responsivity depending on conditions as described above.

For example, there have been proposed methods which involve reducing variations in CD by controlling a rise in wafer temperature when multiple wafers are being continuously processed. As an example of such methods, there is available a method which involves adjusting the flow rate of a coolant for each wafer, the coolant being caused to flow through the interior of an electrode on which a wafer is set (refer to the Japanese Patent Laid-Open Publication No. 2003-203905 (Patent Document 1), for example).

In the above-described conventional art, no consideration is given to the adjustment of the temperature distribution in the plane of the wafer. Particularly, in a case where etching conditions change in stages to adapt to kinds of films as in the continuous etching of a bottom anti-reflection coating and polysilicon, it is necessary to reduce CD variations in the plane of the wafer by realizing an optimum temperature distribution under each condition, and in such a case, the conventional art had problems.

The first object of the present invention is to provide, at low cost, an electrostatic chuck capable of changing an in-plane temperature distribution within the electrostatic chuck with good responsivity. The second object of the present invention is to provide a wafer processing apparatus capable of changing the temperature distribution in the plane of the wafer during plasma processing with good responsivity. The third object of the present invention is to provide a wafer processing method with few CD variations in the plane of the wafer.

### SUMMARY OF THE INVENTION

The above objects are achieved by providing, within a plasma processing apparatus, an electrostatic chuck which comprises a base material in which multiple coolant grooves are formed, a high resistance layer which is formed on the base material, multiple heaters which are formed by thermally spraying conductors within the high resistance layer, and multiple electrostatic chuck electrodes which are formed similarly by thermally spraying conductors within the high resistance layer.

Furthermore, the above objects are achieved by measuring the base material temperature of the electrostatic chuck, for which it has become apparent beforehand that it is possible to find a correlation to the wafer temperature distribution, by use of temperature measuring means provided on a back surface of the wafer, and adjusting outputs of the heaters on the basis of this temperature information. Also, the temperature prediction of the wafer can be achieved by measuring the resistance of the heaters formed by a thermal spray method or the resistance of a resistance bulb disposed very close to the wafer or measuring the temperature of the heaters or the resistance bulb and making a prediction from the measured values.

According to the present invention, the heaters can be formed in positions close to the wafer and, therefore, the wafer temperature distribution can be changed with good responsivity. Also, because it is possible to provide an electrostatic chuck in which the heaters are buried by thermal spraying, it is possible to reduce the cost of manufacturing compared to a case where heaters are built in sintered body ceramics. Also, according to the present invention, because it is possible to simply and accurately predict wafer temperature and to readily realize the control of the heaters in the electrostatic chuck in which the heaters are buried by thermal spraying, a wafer processing apparatus excellent in the controllability of the wafer temperature distribution is obtained. In addition, according to the present invention, it is possible to change the temperature distribution in the plane of the wafer for each etching condition and, therefore, it is possible to realize a processing method with few CD variations in the plane of the wafer.

### BRIEF DESCRIPTION OF THE DRAWINGS

FIG. 1 is a schematic illustration showing the general system configuration including an electrostatic chuck of a first embodiment;

FIG. 2 is a detailed sectional view of the electrostatic chuck of the first embodiment to explain a power feed section to a temperature monitor, a heater and an electrode;

FIG. 3 is a pattern diagram of the heater and electrode of the electrostatic chuck;

FIGS. 4A and 4B are diagrams to explain the effect of the first embodiment of the present invention;

FIG. 5 is a diagram to explain an example in which different kinds of films are continuously treated by using the first embodiment of the present invention;

FIGS. 6A and 6B are diagrams showing a temperature distribution which makes uniform the CD distribution in the wafer plane of a BARC and polysilicon in the first embodiment of the present invention;

FIG. 7 is a diagram to explain a time chart when the first embodiment of the present invention is operated;

FIG. 8 is a sectional view of a second embodiment of the present invention;

FIGS. 9A and 9B are diagrams to explain other examples of a heat pattern;

FIG. 10 is a diagram showing the resistivity of a thermally sprayed tungsten film; and

FIG. 11 is a groove pattern diagram of an electrostatic chuck.

### DETAILED DESCRIPTION OF THE PREFERRED EMBODIMENTS

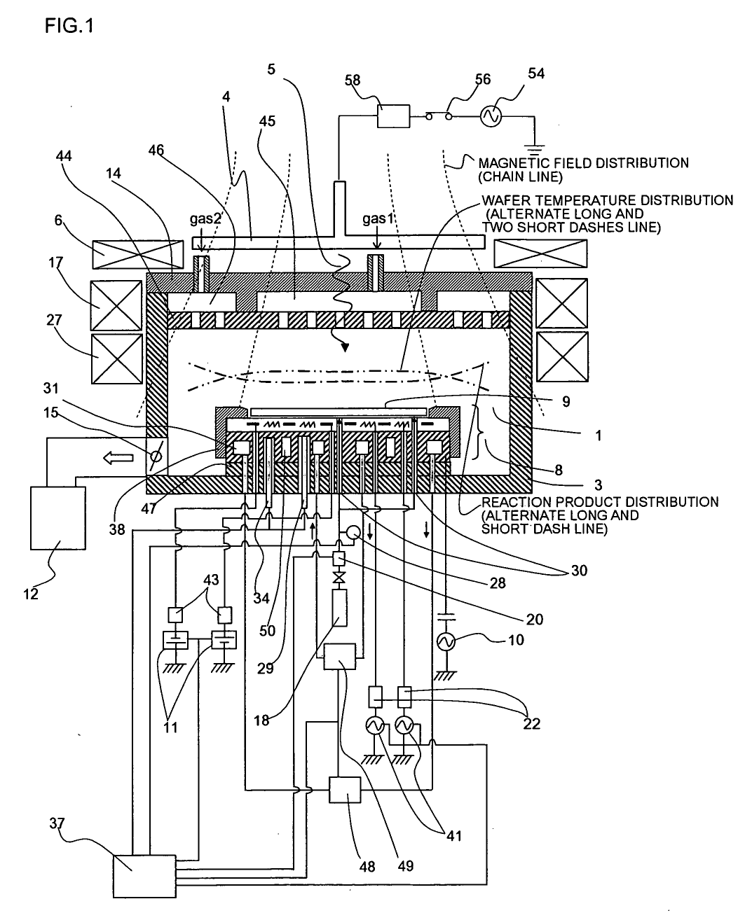

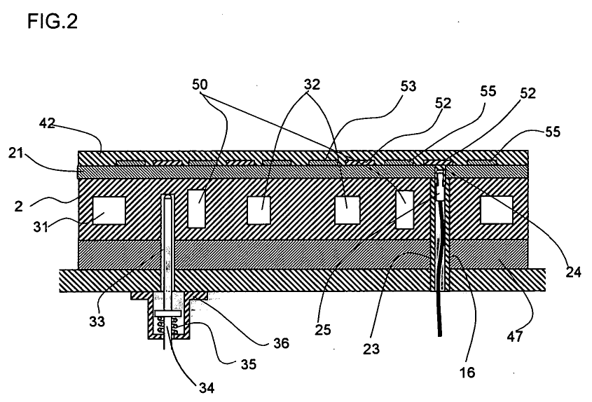

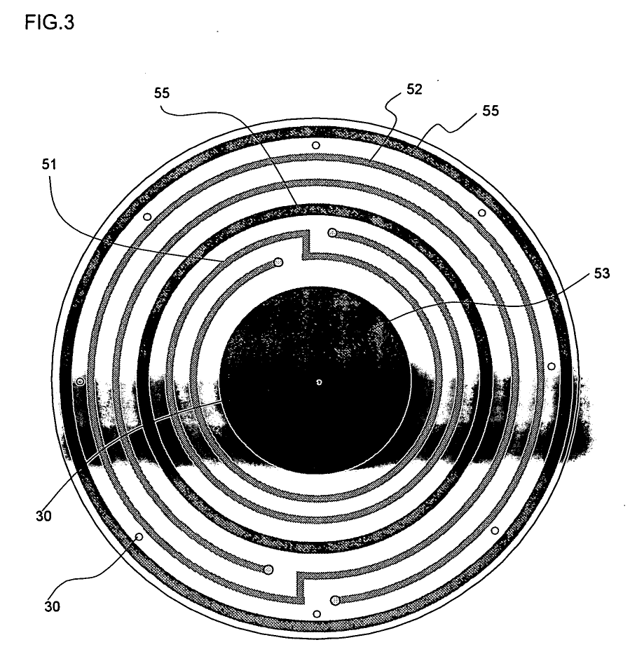

FIGS. 1 to 3 show a first embodiment of the present invention applied to a UHF plasma processing apparatus. FIG. 1 is a schematic illustration showing the general system configuration including an electrostatic chuck of the first embodiment, and this example can explain the technical philosophy of the present invention. FIG. 2 is a detailed sectional view to explain a power feed section to a temperature monitor, a heater and an electrode of the electrostatic chuck of the first embodiment. FIG. 3 is a pattern diagram of the heater and electrode of the electrostatic chuck. First, with reference to FIGS. 1, 2 and 3, the technical philosophy and general system configuration of the present invention will be described.

A shower head plate 44 made of quartz and a treatment chamber lid 14 made of quartz are installed in an upper part of a vacuum chamber 3. Between the treatment chamber lid 14 and the shower head plate 44, there is provided a space which uniformly disperses a treatment gas within a treatment chamber 1 (an inner circumferential gas accumulation area 45 and an outer circumferential gas accumulation area 46), and in this space, a portion near the center and a portion near the outer circumstance are separated by being sealed with an 0-ring (not shown) or the like. The inner circumferential gas accumulation area 45 and the outer circumferential gas accumulation area 46 are constructed in such a manner that they can respectively receive treatment gasses having different flow rate ratios or composition ratios (gas 1 and gas 2 in the figure). Because the shower head plate 44 is provided with a large number of through holes having a diameter of not more than 1 mm or so, it is possible to introduce a treatment gas having a radial distribution of flow rate and composition ratio into the treatment chamber 1. As a result of this, the distribution of depositable radicals and the distribution of reaction products when a plasma is generated within the treatment chamber 1 can be controlled at will and it is possible to make the etching characteristics in the plane of a wafer 9 uniform. In order to generate a plasma, a circular antenna 4 is installed in an upper part of the treatment chamber lid 14, a high frequency power source 54, an on-off switch 56 for high frequency wave application and a matching apparatus 58 which mates impedance during the application of a high frequency wave are connected to this antenna, and high frequency wave voltage (UHF voltage in this embodiment) is applied to the antenna 4. As a result, an electromagnetic wave 5 is introduced into the treatment chamber 1, and owing to an interaction of this electromagnetic wave with magnetic fields generated by coils 6, 17, 27 disposed around the vacuum chamber it is possible to generate a high density ECR (electron cyclotron resonance) plasma. In this embodiment, the coils are installed as three systems and the height of the ECR generated by the plasma can be adjusted at will because the magnetic field distribution indicated by broken lines in the figure can be changed by adjusting each coil current. As a result of this, the plasma distribution during treatment can be controlled and the etching characteristics in the plane of the wafer can be made uniform.

Although in this embodiment the seal of the gas accumulation areas 45 and 46 is realized by an O-ring interposed between the treatment chamber lid and the shower head plate, it is also possible to make the seal by bonding two quartz members together. In this case, it is expected that the corrosion of the 0-ring by the gasses and the occurrence of foreign matter resulting from the corrosion can be suppressed.

In a lower part of the vacuum chamber 3, an electrostatic chuck 8 is disposed via an insulating member 47. As shown in FIG. 2, this electrostatic chuck 8 is constructed in such a manner that a dielectric film of alumina 42 is formed by thermal spraying on a surface of a base material 2 of titanium in which two concentrically formed independent coolant grooves 31, 32 are built. Temperature adjusters 48, 49 are independently connected to each groove, and the temperature of the surface of the electrostatic chuck 8 can be adjusted by causing a coolant having different temperatures to circulate through each groove. Set temperatures of these temperature adjusters are controlled by output signals from a controller 37 which controls the whole device. Also, in this embodiment, a vacuum heat insulating layer 50 is provided in order to reduce heat conductive between the two coolant grooves. As a result of this, it is possible to reduce the capacity of a heater and a refrigerator which are built in the temperature adjuster and, therefore, the temperature adjuster can be miniaturized. Also, because the in-plane temperature distribution of the wafer occurs readily, the controllability of wafer temperature increases.

Within the dielectric film 42 of the electrostatic chuck 8, as shown in FIG. 3, there are incorporated an inner heater 51 and an outer heater 52 of two systems, which are independent of each other, and two electrostatic chuck electrodes, i.e., an inner electrode 53 near the center and outer electrodes 55 disposed along an outer circumference. And AC power sources 41 are independently connected to the inner heater 51 and the outer heater 52 via filters 22 so that power can be supplied. DC power sources 11 are connected to the electrostatic chuck electrodes via filters 43, and in this embodiment, positive voltage is applied to the inner electrode 53 and negative voltage to the outer electrodes 55. Therefore, the electrostatic chuck 8 of this embodiment operates as what is called a bipolar type electrostatic chuck and can attach and detach the wafer regardless of the presence or absence of a plasma.

A high frequency power source 10 for applying bias voltage to the wafer is connected to the base material 2 from behind, and anisotropic etching is performed by drawing the ions in a plasma into the wafer. At this time, heat input to the water occurs. A rise in wafer temperature resulting from this heat input has a great effect on etching performance. Therefore, it is necessary to cool the wafer. However, because the pressure in the treatment chamber 1 is reduced to several pascals or so, heat transfer is insufficient if the wafer is simply placed on the electrostatic chuck 8. Therefore, through holes 30 are provided in the center of the electrostatic chuck 8 and near the outer circumference thereof, and a cooling gas 18 such as helium is introduced from these holes. As a result of this, an unnecessary temperature rise of the wafer is suppressed by ensuring the thermal conductivity between the wafer and the ceramics film. Incidentally, though not described in detail in this embodiment, the groove pattern of the surface of the electrostatic chuck 8 is optimized so that the helium gas introduced from the center spread thoroughly to the outer circumference of the wafer while minimizing pressure losses.

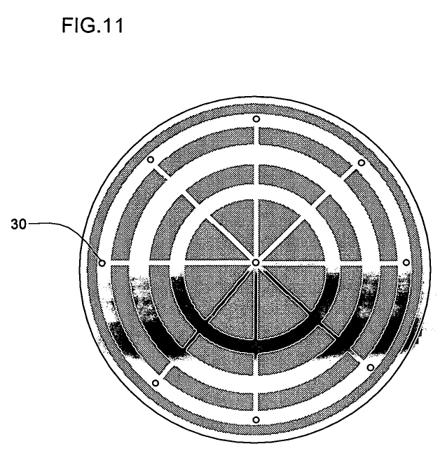

An example of a groove pattern is shown in FIG. 11. The through holes 30 are provided within the grooves in the center part and near the outer circumference. The reference numeral 28 denotes a pressure gauge, and measured values are sent to the controller 37.

The reference numeral 20 denotes a pressure control apparatus, which is controlled by the controller 37. The reference numeral 38 denotes a cover made of alumina to protect the periphery of the electrostatic chuck 8 from a plasma. Although the material is alumina in this embodiment, quartz and other ceramics may also be used, and an appropriate material is selected in consideration of plasma resistance, pollution and foreign matter. For other reference numerals, the numeral 12 denotes a vacuum pump and the pressure in the treatment chamber is adjusted by adjusting the opening of a valve 15 by use of the controller 37.

The wafer temperature during processing is detected by measuring the temperature of the base material 2, for which in this embodiment it has become apparent beforehand that it is possible to find a correlation to the wafer temperature distribution. Concretely, a recess 33 is provided in the base material 2, and sheathed thermocouples 29, 34 are fixed to the bottom surface of the base material, which is below the inner and outer heaters 52, by use of a spring 35 and a fixing jig 36. When measurements are made by use of sheathed thermocouples, the contact condition of leading ends have a great effect on measurement results. In this embodiment, however, the reliability of measurement results is high, because contact is made by a pressing load by the spring which is always constant. Measurement results of the temperature are sent to the controller 37, which controls heater outputs of the inner heater 51 and the outer heater 52 on the basis of this information. Incidentally, as the thermometer, it is possible to use a platinum resistance bulb, a fluorescent thermometer and a radiation thermometer in addition to the sheathed thermocouple. In a case where foreign matter on the back surface of the wafer becomes almost trivial, it is also possible to make measurements by bringing the leading end of the thermometer into direct contact with the back surface of the wafer.

As another method of monitoring wafer temperature, there is also available a method which involves providing either of the inner heater 51 or the outer heater 52 or a new heater which is thermally sprayed with tungsten separately from the inner heater 51 and the outer heater 52 and measuring the resistance of this heater. That is, when power is inputted to the heater, the resistance of the heater changes according to a surrounding temperature. If the relationship between the temperature and resistance of the heater is grasped beforehand, it is possible to get to know the temperature of the heater by monitoring the resistance of a heater feed line. Because this heater is disposed in a position very close to the surface of the electrostatic chuck 8, it is possible to readily estimate wafer temperature from this temperature. As a similar concept, it is also possible to use a method by which a resistance bulb is buried in the electrostatic chuck 8 instead of a heater and the resistance of this resistance bulb is measured.

Subsequently, the electrostatic chuck 8 of this embodiment will be described in detail with reference to FIGS. 2 and 3. High resistance alumina 21 which becomes the first layer is thermally sprayed on the top surface of the base material 2 of the electrostatic chuck 8. Upon the surface of this high resistance alumina 21, the inner heater 51 and the outer heater 52 which are both made of tungsten and the electrodes 53, 55 for performing electrostatic force, which are similarly made of tungsten, are formed in the same thickness by thermal spraying. If the heater thickness is non uniform, a distribution occurs in calorific value. In this embodiment, therefore, the thickness is controlled to a constant value by performing polishing after thermal spraying. After that, the dielectric film 42 of alumina is thermally sprayed by performing thermal spraying again and the thickness and surface roughness are controlled by polishing the surface. Grooves as shown in FIG. 11 are made by performing blasting after polishing. The groove depth is 20 to 50 microns or so. Therefore, according to this embodiment, because the heaters and the electrodes of the electrostatic chuck 8 are formed by thermal spraying, it is possible to reduce the thickness from the base material to the wafer and a drop in the bias voltage is small. Furthermore, because the heaters can be disposed in positions close to the wafer, the electrostatic chuck 8 obtains excellent temperature responsivity. In comparison with a case where a similar structure is fabricated from sintered body ceramics, the number of manufacturing steps is small in the case where thermal spraying is performed and, therefore, it is possible to hold the cost of manufacturing small.

Furthermore, as another manufacturing step, it is possible to make beforehand both radial grooves and doughnut-shaped grooves along a full circumference in the base material 2 and to perform the thermal spraying of the high resistance alumina 21 on the grooves. Under this method, the base material obtains a surface which reflects the presence of the grooves. By polishing the whole surface after thermal spraying to such an extent that the grooves do not disappear, it becomes possible to control the thickness and surface roughness. The depth of grooves formed by this step is usually 100 to 700 microns or so and it is possible to form grooves which are relatively deep compared to grooves formed by blasting.

Power feed to the heaters and the electrodes is performed from a through hole 16 provided in the high resistance alumina 21 and the base material 2. In this embodiment, as shown in FIG. 2, the through hole 16 is provided beforehand in the base material 2, and a ceramics pipe 23 for electrical insulation is buried in this through hole 16. A socket 24 is buried at the leading end of this pipe. The socket 24 is disposed in such a manner that the end surface thereof is exposed to the surface of the high resistance alumina 21 which becomes the first layer, and tungsten is thermally sprayed on the end surface to obtain an electrically conducting condition. If the plug 25 is inserted so as to fit the mouth of the socket, it is possible to feed power to the heaters and the electrodes. Incidentally, although only one power feed section is shown in the figure of this embodiment, it is needless to say that in actuality, two or more power feed sections are necessary. Although in this embodiment power feed to the heaters is performed from the AC power sources 41, this is not always necessary. DC power sources may also be used.

Incidentally, the patterns of the inner heater 51 and outer heater 52 are disposed in a region of the plane of the wafer where the temperature distribution is to be adjusted. Also in this case, forming the heaters by thermal spraying has a great advantage. That is, in a case where a heater pattern is formed by thermal spraying, it is necessary only that the pattern be made beforehand on a mask and, therefore, there is not great restriction to the shape of the pattern. As a result of this, it is also possible to expect the effect that a power feed port of the heater can be readily disposed at will. In contrast to this, for example, in a case where a sheathed heater or the like is buried in the base material 2, it is not realistic to form a complex heat pattern, because it is difficult to perform bending with a very small curvature owing to the rigidity of the sheath. For example, the heater patterns of FIG. 3 are such that for both the inner heater 51 and the outer heater 52, the patterns are formed with two turns each. This is made possible by forming the heater line between the power feed ports in a pattern which enables the heater line to be bent at an angle of about 90 degrees.

It is practically impossible to realize such a pattern which enables a heater to be bent at an angle of about 90 degrees in a sheathed heater and the like. The reason for this is that if the curvature of bending is too small, there is a possibility that the heater in the sheath may be broken.

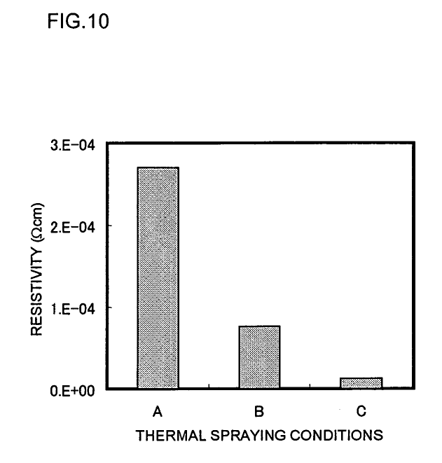

When a heater pattern is arbitrarily adjusted, heater resistance changes according to the length of the heater. However, when a heater pattern is formed by thermal spraying, it is possible to optimize heater resistance by adjusting heater thickness and the resistivity of the heater. FIG. 10 shows changes in resistivity when thermal spraying conditions are changed. As shown in this figure, it is apparent that resistivity can be changed by an order of magnitude or so by changing thermal spraying conditions. Also, because it is possible to from the electrostatic chuck 8 in which heaters are built only by thermal spraying, this provides an advantage also economically. That is, in general, the number of manufacturing steps is smaller when the dielectric film 42 is formed by thermal spraying than it is formed from a sintered body, with the result that the cost of manufacturing can be held small.

The function which is to be eventually realized by the above-described features is that etching results after the processing are uniform in the plane of the wafer. For this purpose, in this embodiment, a plasma distribution which is as uniform as possible is realized by adjusting magnetic fields formed by the coils, the distribution of radicals is adjusted by adjusting the compositions of treatment gasses introduced to the center and near the outer circumference, the adhesion ratio of reaction products is adjusted by producing a difference between the temperature of the coolant which is circulated near the center of the base material and the temperature of the coolant which is circulated near the outer circumference, and in a case where different kinds of films are continuously processed, the temperature distribution is changed by adjusting the power to be inputted to the heaters of two systems for each kind of film. Generally speaking, the density of reaction products is lower near the outer circumference of the wafer than near the center of the wafer. Therefore, uniform etching results are generally obtained by lowering the temperature near the outer circumference to thereby increase the sticking coefficient of reaction products. However, the extent of this lowering of the temperature naturally depends on etching gasses and hence it is necessary to change this extent for each kind of film. However, when the time necessary for this is short, it is good because the processing capacity is not decreased thereby.

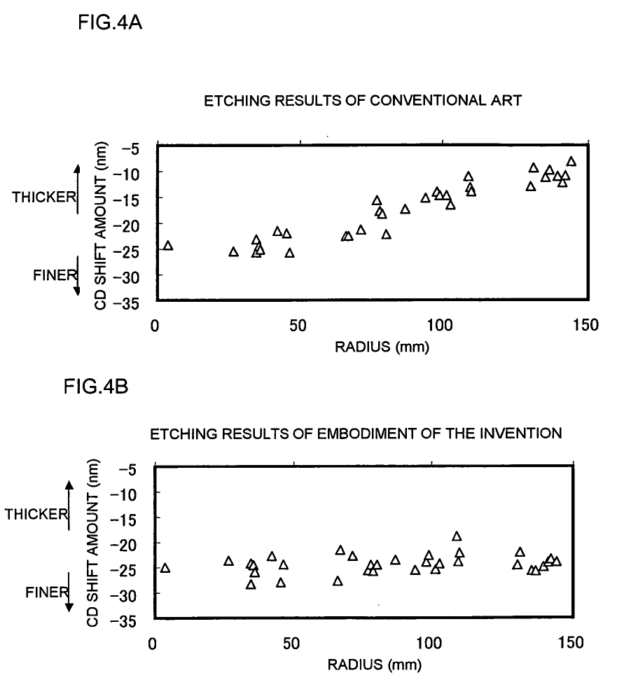

The effect of this embodiment will be described with reference to FIGS. 4A and 4B. FIG. 4A shows the CD shift amount in the plane of the wafer when etching is performed without operating the heaters. From this figure it is apparent that under these etching conditions, the CD shift amount is small near the outer circumstance of the wafer, i.e., the CD tends to be thicker near the outer circumstance than near the center. This is due to the introduction of a large amount of a depositable gas as the treatment gas near the outer circumference, although usually the CD near the outer circumference often becomes finer because reaction products near the outer circumference are easily exhausted. Therefore, by monitoring the temperature of the sheathed thermocouple 29 and sheathed thermocouple 34, power of 50 W was inputted to the inner heater 51 and power of 100 W was inputted to the outer heater 52 so that the temperature of the base material 2 is raised by 3° C. on the sheathed thermocouple 29 and by 5° C. on the sheathed thermocouple 34, and the temperature near the outer circumference was thus raised. Etching was performed in this condition. Results of this etching are shown in FIG. 4B. From this figure it is apparent that by raising the temperature near the outer circumference, the sticking coefficient of reaction products at the outer circumference decreases, with the result that the CD becomes finer and uniform in the plane.

Therefore, because in this embodiment the built-in heaters, insulators of the heaters and base material which constitute the electrostatic chuck, and the dielectric film which provides an electrostatic force mechanism are all fabricated by an inexpensive thermal spraying process, it is possible to provide an electrostatic chuck in which heaters are built at a low cost of manufacturing.

In this embodiment, measurements are made of the temperature of the electrostatic chuck in a base material position, for which it has become apparent beforehand that it is possible to find a correlation to the wafer temperature, and the power inputted to the heaters can be adjusted on the basis of this temperature information, with the result that it is possible to provide a processing apparatus capable of adjusting the temperature distribution in the plane of the wafer. As a result, it is possible to provide a wafer processing apparatus excellent in the CD uniformity in the plane of the wafer.

Incidentally, although the base material 2 is made of titanium in this embodiment, the material for the base material 2 is not always limited to titanium, and materials such as stainless steel and aluminum may also be used. In consideration of the thermal deformation and the like of the base material 2, it is possible to adopt a structure in which, for example, aluminum and titanium are bonded together by brazing. Although tungsten is used as the material for the heaters, other metals such as nickel may also be used. Although in this embodiment alumina is adopted as the material for insulating the base material and the heaters, the insulating material is not limited to alumina and other materials, such as yttria, aluminum nitride and silicon carbide, may also be used.

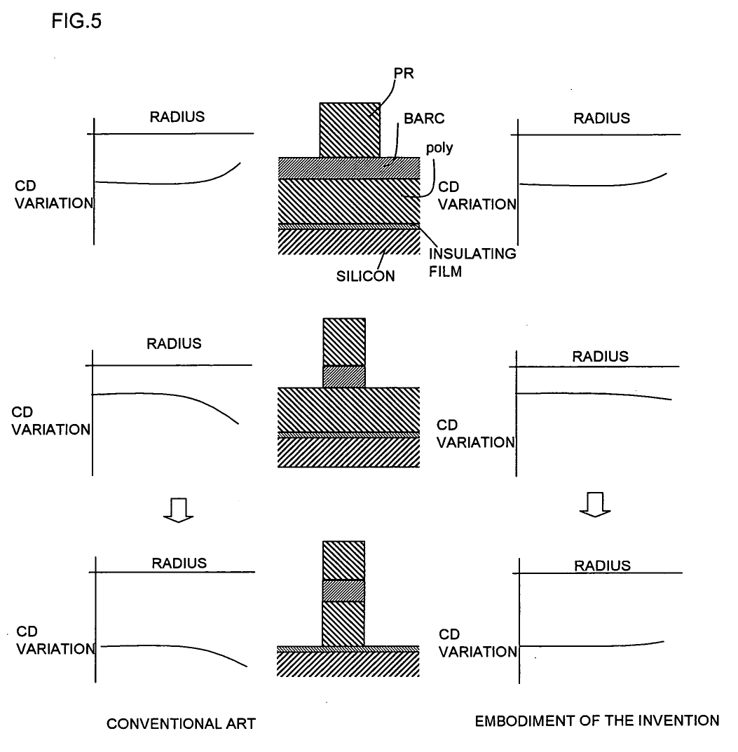

Next, referring to FIG. 5, as an example of continuous treatment of different kinds of films, a description will be given of effects obtained in a case where a bottom anti-reflection coating (BARC) and polysilicon (poly) are continuously treated by use of a resist mask (PR). Usually, in the case of this treatment, a BARC is etched with a mixed gas of chlorine and oxygen and polysilicon is etched with a mixed gas of chlorine, oxygen and hydrogen bromide. In the figure, on the left is shown the CD shift amount after the etching of each film in a case where etching is performed by a conventional art without the operation of heaters. From this figure it is apparent that after the BARC treatment, the CD shift amount is smaller near the outer circumference of the wafer than near the center thereof, that is, the CD near the outer circumference becomes relatively thicker. Contrary to the etching of the BARC, the CD after the etching of the polysilicon has a large shift amount near the outer circumference of the wafer, that is, the CD becomes relatively finer. Eventually, the total CD shift amount in the etching of the BARC and the polysilicon is large near the outer circumference, that is, the CD near the outer circumference resulted in being fine.

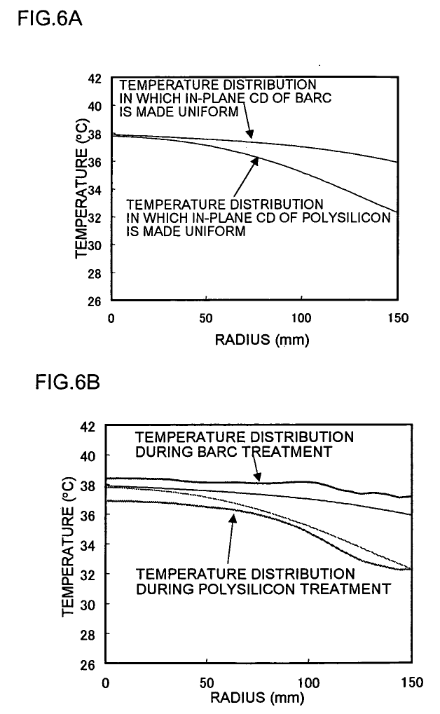

On the basis of these results, an investigation was made into conditions under which the distribution of CD shift amount in the plane of the wafer in the etching of the BARC and polysilicon becomes uniform, and it became apparent that the uniformity is obtained when the BARC and polysilicon have such distribution as shown in FIG. 6A. Incidentally, the conditions were such that plasma generation is interrupted between the treatments of the BARC and the polysilicon and about 10 seconds are required as a time to replace treatment gasses.

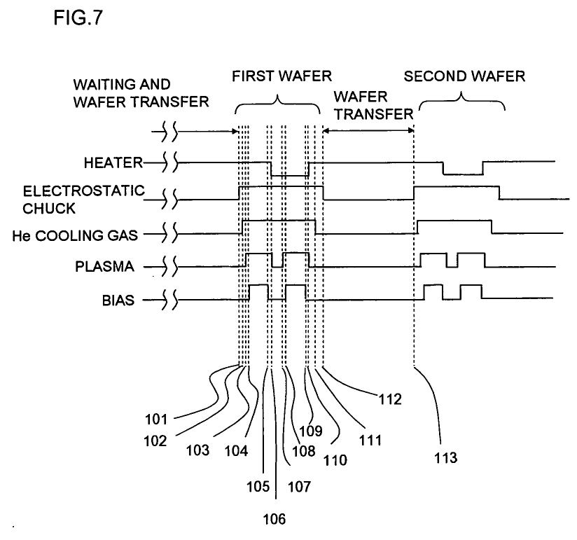

Therefore, treatment was performed on the basis of a time chart as shown in FIG. 7 in consideration of the above circumstances. That is, before the start of the treatment of the first wafer, the temperatures of the coolants which are caused to flow through the inner coolant groove and the outer coolant groove are set at 30° C. and 10° C., respectively, by use of the temperature adjusters 48, 49. If the wafer is treated in this state, the wafer temperature near the outer circumference becomes about 10° C lower than the wafer temperature near the inner circumference, with the result that the temperature becomes different from a temperature at which the CD of BARC is made uniform, as shown in FIG. 6A. Therefore, power of 50 W is inputted to the inner heater 51 and power of 200 W is inputted to the outer heater 52. The wafer temperature at this time obtains a temperature distribution as shown in FIG. 6B, which is almost equal to the temperature distribution in which the CD of BARC is made uniform. After that, the wafer is transferred to the interior of the treatment chamber 1, voltage is applied to the electrostatic chuck 8, and the wafer is chucked (101). After that, a cooling He gas is introduced to the back surface of the wafer (102), a plasma is generated by inputting UHF power (103), and bias power is inputted (104). The application of bias power is stopped at the same time with the end of the BARC treatment (105), the power inputted to the heaters is then stopped for both the inner and outer heaters and the plasma generation is stopped (106). Evacuation to produce a vacuum is performed and the gas is changed over to a gas for polysilicon etching (between 106 and 107). Because power feed by the heaters is stopped for this duration, the temperature of the outer circumference of the wafer drops and obtains a temperature distribution close to a temperature distribution in which the CD of the polysilicon is made uniform. After the end of the duration of this evacuation and gas change over, a plasma is generated by inputting UHF power under the conditions of the polysilicon (107), bias power is inputted (108) and treatment is performed for a duration. The application of bias power is stopped at the same time with the end of the treatment (109), plasma generation is stopped (110) and simultaneously for the treatment of the second wafer, power is inputted to the heaters (110), the cooling He gas is exhausted (111) and the voltage application to the electrostatic chuck is stopped (112). After that, the wafer is transferred from the treatment chamber and the next wafer is transferred into the treatment chamber (between 112 and 113). The same procedure is repeated after that.

Although in this embodiment the timing of the stop of power supply to the heaters after the BARC treatment and the timing of the stop of plasma generation are the same and the timing of application of power to the heaters after the polysilicon treatment and the timing of the stop of plasma generation are the same, it is not always necessary that these operations be performed at the same timing.

A comparison between the case where the treatment is performed under the above-described conditions and the case of a conventional art will be described by making a comparison between the results of measurements of the CD shift amount which were separately made after the BARC treatment and after the polysilicon treatment and the results of measurements of the total CD shift amount. First, for the measurements after the BARC treatment, the CD variation (shift amount) at the outer circumference was small in the treatment by a conventional art, whereas in the present invention, a decrease in variations at the outer circumference was suppressed because the temperature at the outer circumference was raised by inputting power to the heaters and a uniform temperature was obtained.

In the conventional art, after the etching of polysilicon, the CD variation at the outer circumference was great and the CD at the outer circumference tended to become fine. However, because the power inputted to the heaters was zero and the temperature of the coolant caused to flow through the coolant grooves at the inner circumference and the outer circumference was optimized, the CD variation at outer circumference was increased and a substantially flat CD distribution was obtained. The total CD shift amount, which is determined by the CD shift amounts of BARC and polysilicon, was such that the final distribution of CD shift amount was made uniform.

If the treatment is thus performed by adjusting the power for the heater buried at the outer circumference of the wafer according to changes in etching conditions during the treatment, it is possible to realize a temperature at which the CD is made uniform under each etching condition in a short time simply by performing the on-off operation of the heater. Therefore, a CD distribution which is uniform in the plane of the wafer can be obtained.

In this embodiment, BARC and polysilicon temperatures at which the CD is made uniform were realized simply by performing an operation mode in which the on-off operation of the heater is adjusted to the on-off condition of a plasma. However, the present invention is not limited to this operation mode. In this embodiment, there is a duration of 10 seconds between the treatments of the BARC and polysilicon as a duration for changing treatment gases. However, in a case where this duration is to be eliminated or minimized in order to increase the treatment capacity, it is also possible to adopt an operation mode of such a sequence that a difference in the set temperatures of the coolant which is caused to circulate through the inner and outer coolant grooves are set at a larger value and the power to be inputted into the heaters is set at large values of 100 W and 200 W, for example, thereby to realize a temperature at which the CD of BARC is made uniform, and in the treatment of the polysilicon, the heaters are once stopped and power of 20 W and power of 70 W are thereafter inputted respectively to the inner and outer heaters to prevent a difference of temperature of the wafer being processed from being too large.

Furthermore, unlike these modifications, it is also possible to perform feedback control on the basis of information from the thermometers (sheathed thermocouples) 29, 34. However, although outputting from the heaters on the basis of measured temperature data is good when the wafer temperature is directly measured, this poses the problem that a little time response delay occurs while the temperature of the base material 2 is being measured. The reason for this is ascribed to the heat capacity of the base material 2. In this case, it is also conceivable to adopt a method, which is such that as in the period before 101 of FIG. 7, in a period during which there is no heat input to a plasma and hence the problem of response delay does not exist, feedback control is performed on the basis of the temperature of the base material 2 and the on-off control of the heaters or the time control of outputs of the heaters is performed when treatment is started.

In this embodiment, the description was given of a case where in the continuous treatment of the BARC and the polysilicon, there is no great difference in the average wafer temperature. However, in some film qualities, there is a case where a request is made to change the average value of the treatment temperature by 20 ° C. or so. In such cases, it is possible to meet this request by adjusting, for each kind of film, the set pressure of cooling He gas and the voltage applied to the electrostatic chuck 8 which are controlled to fixed values in this embodiment. That is, between a case where the pressure of cooling He gas is set at 1 kPa and a case where this pressure is set at 3 kPa, typically a difference in the heat transfer coefficient which is twice to three times occurs, although this depends on the surface roughness of the dielectric film 42. Therefore, in the case of heat input conditions under which a temperature difference of 5° C. is produced in a layer cooled with He at a pressure of 3 kPa, a temperature rise of 10° C. to 15° C. is expected from a pressure drop to 1 kPa, and the average wafer temperature can be adjusted by utilizing this. Similarly, because adsorption force can be changed by changing the voltage applied to the electrostatic chuck 8, it is possible to adjust the effect of the heat transfer by contact.

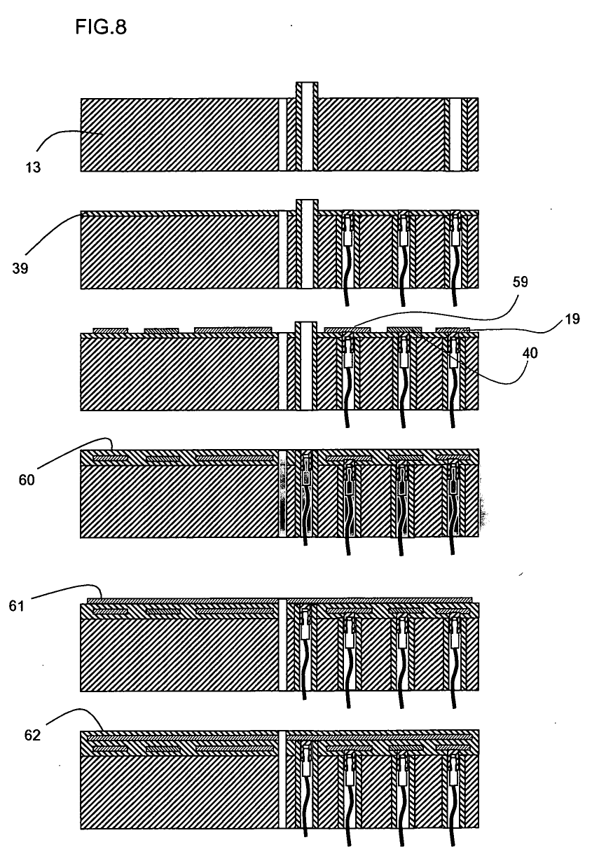

Next, a method of manufacturing an electrostatic chuck of the second embodiment of the present invention will be described with reference to FIG. 8. In this embodiment, unlike the first embodiment, high resistance alumina 39 is thermally sprayed in a uniform manner on a base material 13 of the electrostatic chuck in order to electrically insulate heaters from the base material and the heaters 19, 40, 59 of three systems, which are made of tungsten, are thermally sprayed on the high resistance alumina 39 in the same manner as in the first embodiment. The construction of a power feed section to these heaters is the same as in the first embodiment. High resistance alumina 60 for electrical insulation is further thermally sprayed on these heaters and the ceramics. On top of this high resistance alumina 60, a tungsten electrode 61 for electrostatic force and bias voltage application is further thermally sprayed, and on top of this tungsten electrode 61, a dielectric film 62 is thermally sprayed. The construction of a power feed section to the tungsten electrode may be similar to the construction of the power feed section to the heaters.

Points where the second embodiment differs from the first embodiment will be described below. In the first embodiment, the heaters and the electrode of the electrostatic chuck are disposed at the same height. Therefore, the distance from the wafer to the heaters is short and the construction is excellent in temperature responsivity. However, it is impossible to arrange the heaters on the whole surface. Also, because adsorption force is not generated in the portions of the heaters, this poses the problem that electrostatic force decreases. On the other hand, in the second embodiment, in height positions where the heaters are present, it is possible to arrange all the heaters. Therefore, the whole surface can be uniformly heated and, as described above, the second embodiment has the advantage that an average wafer temperature can be uniformly changed. For adsorption force, because the electrodes are present on the whole area of the back surface of the wafer, the second embodiment provides the advantage that it is easy to ensure a stable electrostatic force. Although in this embodiment the high frequency bias power source applies voltage to the electrostatic chuck electrodes electrode, this is not always necessary and it is also possible that the high frequency bias power source applies voltage to the base material.

In the above-described embodiments, the descriptions were given of an example in which the electrostatic chuck is constructed to have two electrodes, what is called the bipolar type. In the bipolar type, the attaching and detaching of the wafer is possible regardless of the presence or absence of a plasma, and it can be expected that the treatment capacity is improved compared to the unipolar type. However, it is not always necessary that the bipolar type be used. Similar effects can be realized with the unipolar type. In this case, although a plasma is necessary for the adsorption and desorption of the wafer, a large adsorption force can be obtained compared to the case of the bipolar type if the same applied voltage is used. Therefore, it is possible to reduce the set voltage of the DC power source for the electrostatic chuck.

In the above-described embodiments, the buried heaters are of two systems or of three systems. However, although a close temperature distribution can be realized by adjusting the power inputted to each heater, the construction tends to become complex. On the other hand, in some objects of etching, there are cases where temperature control which is close to that required in these embodiments is unnecessary. In this case, it is also possible to provide a heater construction of only one system. In this case, because the construction becomes simple, it can be expected that the cost of manufacturing is reduced.

When the heaters and the electrostatic chuck are arranged flush with each other as in the first embodiment, it is possible to take a large area for the electrodes compared to the case of multiple systems and, therefore, it is possible to make electrostatic force large.

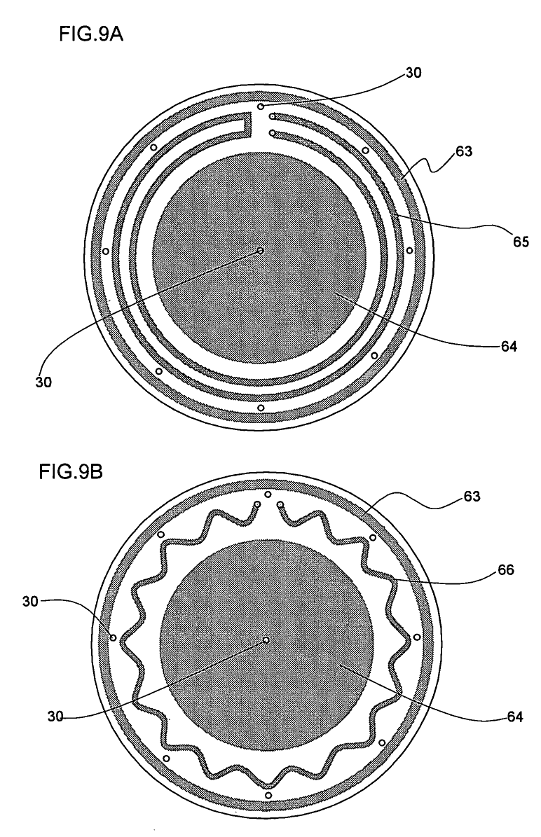

Examples of a heater pattern in this case are shown in FIGS. 9A and 9B. In FIG. 9A, the reference numeral 63 denotes an outer electrode for the electrostatic chuck, the reference numeral 64 denotes an inner electrode, the reference numeral 30 denotes a through hole for introducing a cooling gas, and the reference numeral 65 denotes a heater. In this modification, the forward and backward directions are reverse to those in the first embodiment, and when a DC current is caused to flow through the heaters, magnetic fields which are generated by the heater current act in a direction in which the magnetic fields cancel each other out. Therefore, this produces the effect that there is no influence of magnetic fields at all. However, it has already been ascertained that also in the case of the first embodiment, the extent of magnetic fields generated by the heater current does not exert an effect on usual etching. In FIG. 9B, the reference numeral 63 denotes an outer electrode for the electrostatic chuck, the reference numeral 64 denotes an inner electrode, the reference numeral 30 denotes a through hole for introducing a cooling gas, and the reference numeral 66 denotes a heater. Unlike the first embodiment, in this modification, the heater of one turn is arranged in sine wave form. The advantage of this pattern resides in the point that the resistance of the heater can be relatively freely adjusted by adjusting the cycle of the waveform. In the case of the first embodiment and the pattern of FIG. 9A, although the resistance can be adjusted by adjusting the thickness or width of the heater, from a viewpoint of forming the heater by thermally spraying, variations may sometimes occur in the resistance if the thickness of the heater is made too small or the width is made too small. However, the pattern of FIG. 9B has the advantage that it has a degree of flexibility in the designing of resistance.

What is claimed is:

1. An electrostatic chuck used in a wafer processing apparatus which processes a semiconductor wafer by use of a plasma, comprising:
a base material in which multiple coolant grooves are formed;
a high resistance layer which is formed on the base material;
multiple heaters which are formed by thermally spraying conductors within the high resistance layer; and
multiple electrostatic chuck electrodes which are formed similarly by thermally spraying conductors within the high resistance layer.

2. The electrostatic chuck according to claim 1, wherein the heaters and the electrostatic chuck electrodes are formed to have an equal height within the high resistance layer.

3. The electrostatic chuck according to claim 1, wherein the heaters and the electrostatic chuck electrodes are formed to have different heights within the high resistance layer and the electrostatic chuck electrodes are formed above the heaters.

4. The electrostatic chuck according to claim 1, wherein each of the coolant grooves, heaters and electrodes is concentrically formed.

5. The electrostatic chuck according to claim 4, further comprising temperature measuring means within the base material below a heater on an outer circumferential side.

6. The electrostatic chuck according to claim 1, further comprising means of measuring the resistance of the heaters.

7. An electrostatic chuck used in a wafer processing apparatus which processes a semiconductor wafer by use of a plasma, comprising:
a base material in which multiple coolant grooves are formed;
a high resistance layer which is formed on the base material;
a heater which is formed by thermally spraying conductors within the high resistance layer; and
multiple electrostatic chuck electrodes which are formed similarly by thermally spraying conductors within the high resistance layer,
wherein the heater is formed on a circumference, the heater has, on both ends thereof, connection terminals which are connected to a power source, the connection terminals are disposed in a row along a radial direction of the base material, and a heater line which connects the connection terminals together is formed so as to have a turnaround point near places where the connection terminals are disposed.

8. An electrostatic chuck used in a wafer processing apparatus which processes a semiconductor wafer by use of a plasma, comprising:
a base material in which multiple coolant grooves are formed;
a high resistance layer which is formed on the base material;
a heater which is formed by thermally spraying conductors within the high resistance layer; and
multiple electrostatic chuck electrodes which are formed similarly by thermally spraying conductors within the high resistance layer,
wherein the heater is formed on a circumference, the heater has, on both ends thereof, connection terminals which are connected to a power source, and a heater line which connects the connection terminals together is formed in sine wave form.

9. A wafer processing apparatus which processes a semiconductor wafer by use of a plasma and has an electrostatic chuck for placing the semiconductor wafer thereon,
wherein the electrostatic chuck comprises a base material in which multiple coolant grooves through which a coolant is flowed are formed, a high resistance layer which is formed on the base material, multiple heaters which are formed by thermally spraying conductors within the high resistance layer, multiple electrostatic chuck electrodes which are formed similarly by thermally spraying conductors within the high resistance layer, and temperature measuring means,
wherein the electrostatic chuck further comprises temperature adjusting means which adjusts outputs of the heaters on the basis of information on temperatures measured by the temperature measuring means.

10. The wafer processing apparatus according to claim 9, wherein within the electrostatic chuck there is provided a gas supply flow passage which discharges a cooling gas to between the electrostatic chuck and the semiconductor wafer.

11. The wafer processing apparatus according to claim 9, wherein data which shows a correlation between temperature information obtained by the temperature measuring means and the temperature of the semiconductor wafer is provided and the temperature adjusting means adjusts outputs to the heaters by using the data.

12. A plasma processing method which uses a plasma processing apparatus having an electrostatic chuck for placing a semiconductor wafer thereon, which comprises a base material in which multiple coolant grooves through which a coolant is flowed are formed, a high resistance layer which is formed on the base material, multiple heaters which are formed by thermally spraying conductors within the high resistance layer, multiple electrostatic chuck electrodes which are formed similarly by thermally spraying conductors within the high resistance layer, and temperature measuring means,
wherein power applied to the heaters, flow rate of the cooling gas and power applied to the electrostatic chuck electrodes are adjusted according to a film layer of the semiconductor wafer.

13. The plasma processing method according to claim 12, wherein the multiple heaters are disposed by being divided into a heater on an inner circumferential side and a heater on an outer circumferential side and the inner circumferential side and the outer circumferential side of the heaters are independently temperature controlled according to a film layer of the semiconductor wafer.

14. The plasma processing method according to claim 12, wherein outputs of the heaters are adjusted by using temperature information obtained by the temperature measuring means.
